(19) United States
(12) Patent Application Publication
(10) Pub. No.: US 2006/0117978 A1
(43) Pub. Date: Jun. 8, 2006

(54) Method of sizing paper-backed images for standard sized picture frames

(76) Inventor: Brian Copeland, Brooklyn, NY (US)

Correspondence Address: STEVEN HOROWITZ, ESQ., 295 MADISON AVE, SUITE 700, NEW YORK, NY, 10017, US

(21) Appl. No.: 11/002,862

(22) Filed: Dec. 2, 2004

(51) Int. Cl. B41J 3/407

(52) U.S. Cl. 101/483; 428/43

(57) ABSTRACT

A method for making photographs that are printed off a computer that was inputted with a digital camera, compatible with standard-sized picture frames. It also applies to any graphic material that is printed onto paper using a computer printer. A piece of paper contains perforations at strategic locations so that a person can carefully tear off a border section of the paper outside the perforations and obtain from their standard sized paper (i.e. 8 by 11 inch) a photograph on a paper size that fits neatly into a standard sized picture frame, such 8 by 10 inch or 4 by 6 inch picture frames.

### FIELD OF THE INVENTION

The field of this invention is fitting images on paper into picture frames, and more particularly, methods for fitting paper-backed photographs into standard sized picture frames.

### BACKGROUND OF THE INVENTION AND DISCUSSION OF THE PRIOR ART

With the advent of the digital camera, many photographs are created in a manner different than the traditional way of taking a snapshot and developing the film on photography paper. Rather, the photographic image is obtained by being printed out on ordinary printing paper rather than on photography paper. An image is shot with a digital camera, inputted into a computer, and printed out on to a piece of ordinary printing paper.

It is well known that there is a desire to frame photographs to make them attractive. Picture frames are not generally available in any size but rather come in certain standard sizes. The available standard sizes for picture frame include 8 by 10 inches and 4 by 6 inches. These and other standard sizes for picture frames are designed to be compatible with the size of traditional photographs made on photography paper.

A problem therefore arises as to how to fit the new kind of paper-backed photographs onto a picture frame having the standard sizes, such as 8 by 10 inches or 4 by 6 inches, without the photograph moving around in the frame due to an imperfectly sized fit. Typically, printing paper that one inserts into a computer printer is not compatible in size with standard sized picture frames. Such paper comes in the 8 and a half by 11 inch or in the 8 and a half by 14 inch size. There is also international size or metric size paper called “A4” size which is a little narrower and longer but this printing paper is even less likely to fit perfectly into standard-sized picture frames. Thus, using photographs and other images printed from a computer inputted or scanned from a digital camera would not fit attractively into standard-sized picture frames.

Furthermore, it is not practical to design printing paper specifically sized for printing photographs and other graphical images. For the overwhelming majority of consumers of printers, only a small portion of the things to be printed out on the computer printer are going to be photographs. First of all, it is not clear that the computer printer could easily accommodate the paper size that is compatible with standard sized picture frames. In addition, even if it could, it is not realistic to keep smaller sized paper that fits picture frames perfectly in the printer all the time. In addition, it is bothersome to have smaller paper for picture frames handy outside the printer and then insert this paper into the printer whenever the printer is being used to print photographs derived from a digital camera. One would have to change the paper size in the printer every time you print out a photograph. This is cumbersome. Typically, therefore, today photographs are just printed out on 8 and ½ by 11 inch sized paper or perhaps 8 by 14 inch paper.

It is necessary to determine how to frame a photograph the size of 8 and ½ by 11 inches when the picture frames typically accommodate pictures sized at 8 by 10 inches or 4 by 6 inches or other standard picture sizes. If one would simply cut the paper-backed photograph with a scissor or other instrument, it would not be accurate and it would take time. Furthermore, if such cutting inadvertently veered into the image portion of the paper and destroyed part of the photograph it would take still more time to reprint the photograph and start the cutting process over again. In addition, in order to make the process accurate, one would have to measure the picture frame and mark out lines on the paper-backed photograph. This is cumbersome and time-consuming.

Moreover, although pre-perforated copy paper is known, see “www.gotoforms.com”, this copy paper is sized for statements containing removable invoices and other purposes and is not designed for picture frames.

There is therefore a compelling need for an efficient way of making photographs that derive from digital cameras compatible with standard sized picture frames. Furthermore, there is need for making any graphic image on paper compatible with standard sized picture frames. Known software for example allows a user to create certificates. However, there is no efficient way to make the certificate fit into standard sized picture frames.

In addition, many in educational institutions or other settings desire to have the capability of displaying famous quotations in an appealing manner for educational purposes. This means placing the “quotable quote” into a picture frame. With the advent of the computer, it is most common to simply print out the quotation in an appealing font. The problem of making the printing paper compatible with standard sized picture frames still remains. Thus there is compelling need for rendering any graphic material printed off a computer compatible with standard sized picture frames.

### SUMMARY OF THE PRESENT INVENTION

The present invention is a method and apparatus for making “paper photographs”, meaning photographs that are printed off a computer that was inputted with a digital camera, compatible with standard-sized picture frames. It also applies to any graphic material that is printed onto paper using a computer printer.

The present invention utilizes an apparatus that comprises a piece of paper containing perforations at strategic locations so that a person can carefully tear off a border section of the paper outside the perforations and obtain from their standard sized paper (i.e. 8 by 11 inch) a photograph on a paper size that fits neatly into a standard sized picture frame.

For example, to accommodate 8 inch by 10 inch picture frames the 8 and ½ inch by 11 inch paper would have a series of perforations in linear configurations set off from the edges of the paper. When the printing paper is held upright like one holds a paper when reading normally, each of the two longer vertical sides of the sheet have a series of perforations in linear configuration, the perforations being approximately one quarter inches from each vertical side. Similarly, the top and bottom horizontal series of perforation would be set off approximately half an inch from the top and bottom edges of the paper. The perforations together form a rectangle and divide the paper into a border section and an image section.

The method of the present invention involves providing a piece of paper having the aforementioned perforations, printing a photograph on to the paper having the perforations compatible with the desired picture frame size, tearing off (after folding, if necessary) the border section from the image section of the printing paper and inserting that paper into the picture frame accommodating that sized paper.

### IMPORTANT OBJECTS AND ADVANTAGES

The following important objects and advantages of the present invention are:

(1) to provide a method of making photographs from digital cameras compatible with standard-sized picture frames;

(2) to provide such a method that is suitable for any size picture frame including both 8 by 10 inch and 4 by 6 inch sized picture frames;

(3) to provide such a method that employs perforated printing paper;

(4) to provide such a method that utilizes photographs printing off a printer controlled by a computer inputted by a digital image from a digital camera;

(5) to provide such a method that allows a user to frame a certificate containing a seal or ribbon on it that was created by software;

(6) to provide a method of framing graphic images into standard-sized picture frames;

(7) to provide a method of framing digital camera based photographs in standard-sized picture frames so that the photographs fit in the frames perfectly and do not move around;

(8) to provide a method of securely framing images, such as photographs, that have been printed onto paper using a computer;

(9) to provide a method of securely framing graphical images in standard sized picture frames;

(10) to provide a method of attractively framing photographs and other images printed onto paper from computers that have been inputted using digital cameras;

(11) to provide such a method that is not time consuming;

(12) to provide a method as above that is versatile enough to be applied to any size paper and any size picture frame; and

(13) to provide a method as above that is very easy to implement and does not require new equipment.

### BRIEF DESCRIPTION OF THE DRAWINGS

FIG. 1 is a perspective view of printing paper having a series of perforations near the left, right, top and bottom edges whose border section is being removed so that the image section can be inserted into an 8 by 10 inch picture frame.

FIG. 2 is a perspective view of printing paper having a series of perforations near the left, right, top and bottom edges whose border section is being removed so that the image section can be inserted into a 4 by 6 inch picture frame.

### DETAILED DESCRIPTION OF THE PREFERRED EMBODIMENT

The method of the present invention will now be illustrated by reference to the accompanying drawings. The printing paper used in the method of the present invention has been assigned reference numeral 10 Other elements have been assigned the reference numerals referred to below.

Preliminarily, it is noted that the present invention applies to the kind of picture frames for which it is physically possible to insert a photograph or any paper into the picture frame. This is typically done by insertion of the photograph into the rear of the picture frame.

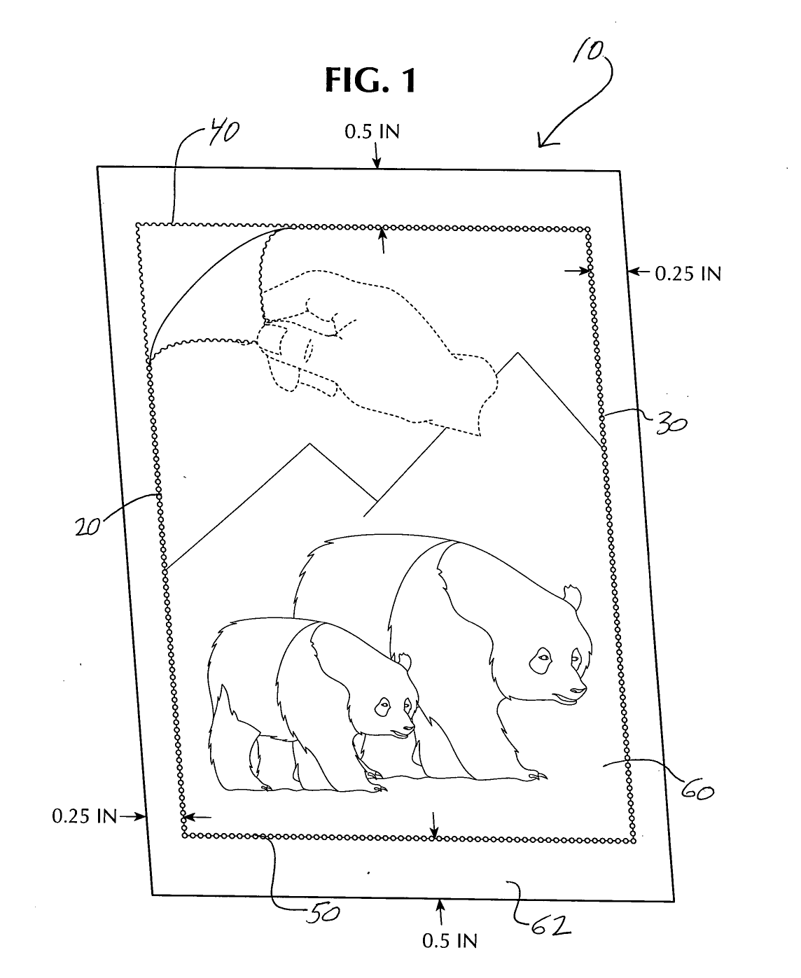

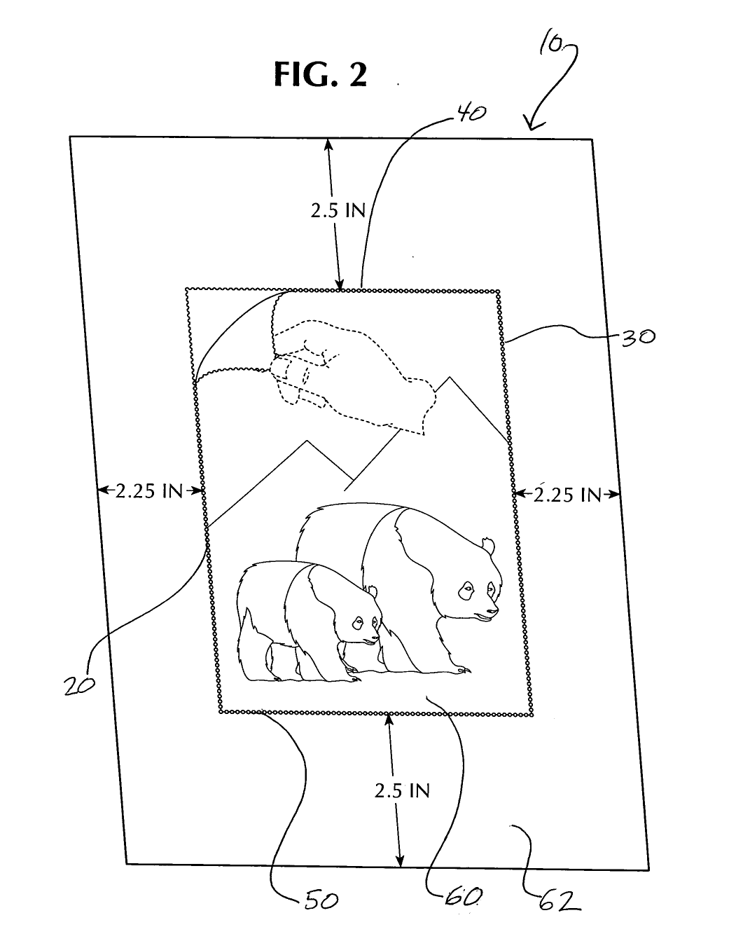

As seen from FIGS. 1-2, a method of rendering paper-backed photographs compatible with standard-sized 8 by 10 inch or 4 by 6 inch picture frames is presented. The paper-backed photographs are of the kind printed from a computer that was inputted with a digital image from a digital camera.

The method comprises providing a piece of 8 and a half by 11 inch printing paper 10 having a top edge, a bottom edge, a left edge and a right edge. For picture frames that are 8 by 10 inches, the printing paper 10 has thereon a first series of perforations 20 in a linear configuration located approximately one quarter inch from the left edge, a second series of perforations 30 in a linear configuration located approximately one quarter inch from the right edge, a third series of perforations 40 in a linear configuration located approximately one half inch from the top edge and a fourth series of perforations 50 in a linear configuration located approximately one half inch from the bottom edge. Similarly, for picture frames that are 4 by 6 inches the first and second series of perforations 20, 30 in linear configuration are located approximately two and a quarter inches from the left edge and right edge respectively, and the third and fourth series of perforations 40, 50 in linear configuration are located approximately two inches from the top edge and bottom edge respectively.

The first series 20, second series 30, third series 40 and fourth series 50 of perforations collectively divide the printing paper in an image section 60 and a removable border section 62.

In accordance with the method of the present invention, one then places the printing paper into a printer controlled by a computer that is capable of receiving digital images from digital cameras, printing a photograph from the digital image on to the printing paper, if necessary folding the printing paper and tearing along the first, second, third and fourth series of perforations to remove the border section from the image section of the printing paper.

For 4 by 6 picture frames the perforation rectangle would either be set much farther inward from the paper borders than for 8 by 10 inch frames, as stated, or in certain alternative embodiments, for 4 by 6 picture frames, the printing paper would contain two separate perforation rectangles that would be delineated, each of which would be lying horizontally. Preferably, although not necessarily, the two perforation rectangles enclosing the image sections of the printing paper would be contiguous. In this case, where the image section is laid out horizontally, the user's computer software would have to be used to rotate and position the image/photograph so that when printed it fits into the image section of the paper. This is a formatting function that is commonly performed when printing from a computer onto postcards.

In this case, where the image section is laid out horizontally, for 4 by 6 picture frames, there would be two horizontal image sections on the 8 and a half by 11 inch, each one having a first series of linear perforations approximately 1 and a quarter inches from the left vertical edge, a second series of linear perforations approximately 1 and a quarter inches from the right edge, a third series of linear perforations located approximately three quarters of an inch from the horizontal midpoint of the paper and a fourth series of linear perforations located approximately three quarters of an inch from the bottom (or top) of the paper.

Typically, for a picture frame of a particular size the picture in the frame should not be so small that it “swims” in the frame and can move around excessively. Rather it should be the right size, which is identical or slightly smaller than the size called for by the picture frame. Thus the perforations must be at positions that are closely calibrated distances set off from the border of the paper.

It should be appreciated that the method of the present invention can also be applied to printing paper of sizes other than 8 and a half inch by 11 with simple modification. For example, for 8 and a half by 14 inch paper, the third series of perforations should be located approximately two inches from the top edge and the fourth series of perforations should be located approximately two inches from the bottom edge. The first and second series of perforations would be located one quarter inch from the respective left and right edges, as before.

Thus, the method of the present invention can be generalized wherein the first step involves providing printing paper having a left edge, a right edge, a top edge and a bottom edge, the printing paper having thereon a first series of perforations in a linear configuration located approximately X inches from the left edge, a second series of perforations in a linear configuration located approximately X inches from the right edge, “X” representing approximately half the difference between a width of the printing paper and a width of the picture frame, a third series of perforations in a linear configuration located approximately Y inches from the top edge and a fourth series of perforations in a linear configuration located approximately Y inches from the bottom edge, “Y” representing approximately half the difference between a length of the printing paper and a length of the picture frame.

It is noted that while FIGS. 1 and 2 show a human hand pulling the image section 60 off the border section 62 from a corner, this is simply illustrative and is not intended to depict the actual best way for a person to separate the border section 62 from the image section 60 of the printing paper. In actual practice it is likely to be easier to fold along the perforations and then use two hands to separate the two sections 60, 62 from one another in any convenient manner. Furthermore, it is noted in FIG. 1 that the distances refer to the approximate width of the border section 62. In addition, the image depicted in FIGS. 1 and 2 are purely illustrative. Therefore, in actual practice the image will not occupy the full width of the image section 60 since the frame of the picture frame must be taken into account so that the frame does not block any important part of the image.

Furthermore, it is noted that all distances used herein are intended to be very approximate and in particular the size of the picture frame as 8 by 10 inches or 4 by 6 inches is intended to be approximate since there may be some small difference between the official width of the frame and the actual width of a paper inserted into the back of the frame.

The present invention contemplates that image section 60 not be centered vertically or horizontally in printing paper 10. Thus the term “approximately” when used to described the width and length of border section 62, i.e. the distance from a particular series of linear perforations 20, 30 40, 50 to one of the corresponding edges of the printing paper 10, is to taken broadly enough to encompass embodiments in which the image section 60 is not centered in printing paper 10 vertically and/or horizontally. Although not preferred, nonetheless, the size of the width of one vertical strip of border section 62 can therefore be anywhere between zero and twice the size given in the preferred embodiment where image section 60 is centered. Thus, if the size of one vertical strip of border section 62 were close to zero, the size of the other vertical strip of border section 62 would be close to twice the size given in the preferred embodiment in which the image section 60 is centered horizontally. Similarly, although not preferred, if the border section were not centered vertically, then if for example the thickness of the top of border section 62 were almost twice the size given in the preferred embodiment, then the thickness of the bottom section of border section 62 would be close to zero, and vice versa.

It is to be understood that while the method of the present invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. A method of rendering paper-backed images compatible with standard-sized 8 by 10 inch picture frames, said paper-backed images printed from a computer that was inputted with a digital image from a digital camera, the method comprising:
providing a piece of 8 and a half by 11 inch printing paper having a top edge, a bottom edge, a left edge and a right edge, the printing paper having thereon a first series of perforations in a linear configuration located approximately one quarter inch from the left edge, a second series of perforations in a linear configuration located approximately one quarter inch from the right edge, a third series of perforations in a linear configuration located approximately one half inch from the top edge and a fourth series of perforations in a linear configuration located approximately one half inch from the bottom edge, the first, second, third and fourth series of perforations collectively dividing the printing paper into an image section and a removable border section, placing the printing paper into a printer controlled by a computer that is capable of receiving digital images from digital cameras,
printing the image on to the printing paper from the digital image in the computer, removing the border section from the printing paper by tearing along the first, second, third and fourth series of perforations.

2. The method of claim 1, wherein the image is a photograph.

3. A method of rendering paper-backed images compatible with standard-sized 4 by 6 inch picture frames, said paper-backed images printed from a computer that was inputted with a digital image from a digital camera, the method comprising:
providing a piece of 8 and a half by 11 inch printing paper having a top edge, a bottom edge, a left edge and a right edge, the printing paper having thereon a first series of perforations in a linear configuration located approximately two and one quarter inches from the left edge, a second series of perforations in a linear configuration located approximately two and one quarter inches from the right edge, a third series of perforations in a linear configuration located approximately two and one half inches from the top edge and a fourth series of perforations in a linear configuration located approximately two and one half inches from the bottom edge, the first, second, third and fourth series of perforations collectively dividing the printing paper into an image section and a removable border section,
placing the printing paper into a printer controlled by a computer that is capable of receiving digital images from digital cameras,
printing the image on to the printing paper from the digital image in the computer, removing the border section from the printing paper by tearing along the first, second, third and fourth series of perforations.

4. The method of claim 3, wherein the image is a photograph.

5. A method of framing an image on standard-sized 8 by 10 inch picture frames, comprising:
providing a piece of 8 and a half by 11 inch printing paper having a top edge, a bottom edge, a left edge and a right edge, the printing paper having thereon a first series of perforations in a linear configuration located approximately one quarter inch from the left edge, a second series of perforations in a linear configuration located approximately one quarter inch from the right edge, a third series of perforations in a linear configuration located approximately one half inch from the top edge and a fourth series of perforations in a linear configuration located approximately one half inch from the bottom edge, the first, second, third and fourth series of perforations collectively dividing the printing paper into an image section and a removable border section, placing the printing paper into a printer controlled by a computer that is capable of receiving digital images from digital cameras,
printing the image on to the printing paper from the digital image in the computer,
removing the border section from the printing paper by tearing along the first, second, third and fourth series of perforations and
placing the image section into the picture frame.

6. The method of claim 5, wherein the image is a photograph.

7. A method of framing graphic material on standard-sized 4 by 6 inch picture frames, comprising
providing a piece of 8 and a half by 11 inch printing paper having a top edge, a bottom edge, a left edge and a right edge, the printing paper having thereon a first series of perforations in a linear configuration located approximately two and one quarter inches from the left edge, a second series of perforations in a linear configuration located approximately two and one quarter inches from the right edge, a third series of perforations in a linear configuration located approximately two and one half inches from the top edge and a fourth series of perforations in a linear configuration located approximately two and one half inches from the bottom edge, the first, second, third and fourth series of perforations collectively dividing the printing paper into an image section and a removable border section,
placing the printing paper into a printer controlled by a computer that is capable of receiving digital images from digital cameras,
printing the image on to the printing paper from the digital image in the computer,
removing the border section from the printing paper by tearing along the first, second, third and fourth series of perforations and
placing the image section into the picture frame.

8. The method of claim 7, wherein the image is a photograph.

9. A method of rendering paper-backed images compatible with standard-sized 8 by 10 inch picture frames, said paper-backed images printed from a computer that was inputted with a digital image from a digital camera, the method comprising:
providing a piece of 8 and a half by 11 inch printing paper having a top edge, a bottom edge, a left edge and a right edge, the printing paper having thereon a first series of perforations in a linear configuration located approximately X inches from the left edge, a second series of perforations in a linear configuration located approximately X inches from the right edge, “X” representing approximately half the difference between a width of the printing paper and a width of the picture frame, a third series of perforations in a linear configuration located approximately Y inches from the top edge and a fourth series of perforations in a linear configuration located approximately Y inches from the bottom edge, “Y” representing approximately half the difference between a length of the printing paper and a length of the picture frame,
the first, second, third and fourth series of perforations collectively dividing the printing paper into an image section and a removable border section,
placing the printing paper into a printer controlled by a computer that is capable of receiving digital images from digital cameras,
printing the image on to the printing paper from the digital image in the computer,
removing the border section from the printing paper by tearing along the first, second, third and fourth series of perforations.

10. The method of claim 9, wherein the image is a photograph.
